(19) United States
(12) Patent Application Publication
(10) Pub. No.: US 2026/0186591 A1
(43) Pub. Date: Jul. 2, 2026

(54) SYSTEM AND METHOD OF TOOL IDENTIFICATION FOR AN INTERACTIVE INPUT SYSTEM

(71) Applicant: SMART Technologies ULC, Calgary (CA)

(72) Inventors: Rola BAKI, Calgary (CA); Chris NICOL, Calgary (CA); Randall FERNANDES, Calgary (CA); Colin GOWEN, Calgary (CA)

(73) Assignee: SMART Technologies ULC, Calgary (CA)

(21) Appl. No.: 18/937,099

(22) PCT Filed: May 9, 2023
(86) PCT No.: PCT/CA2023/050631

§ 371 Date: Nov. 5, 2024

(51) Int. Cl. G06F 3/038; G06F 3/0354; G06F 3/041

(52) U.S. Cl. CPC G06F 3/0383; G06F 3/03545; G06F 3/04162

(57) ABSTRACT

An interactive input system, a tool and a method for detecting the tool's identity in the interactive input system are provided, in which a touch location of the tool is detected. The system comprises a tool detection module comprising at least one energy harvest transmitter, a transceiver, and a microcontroller. The at least one energy harvest transmitter transmits radio frequency (RF) signals to provide power to the tool. The transceiver scans transmit packets containing identity data broadcasted from the tool. The microcontroller is configured to determine the identity (ID) of at least one tool and associates the ID with an tribute. The tool may comprise a plurality of sensors, such as a tip switch, a vibration sensor or a magnetic sensor for saving the power of the tool when the tool is not in use.

### FIELD

This invention is in the field of interactive input systems and methods, and more specifically to identification of passive and active tools used in conjunction with an interactive input system.

### BACKGROUND

U.S. Pub. No. 2013/0257825 to SMART Technologies ULC, the contents of which are herein explicitly incorporated by reference in its entirety, discloses a pen tool brought into proximity with an interactive surface during image frame capture. An image sensor of an imaging assembly may see a bright region having a high intensity above the bright band corresponding to infrared illumination that impinges on a filtered reflector of the pen tool and is filtered and reflected by reflective and filtering elements. If the filtering element of the pen tool does not have the same passband as the IR-bandpass filter associated with an IR LED that is ON, the image frame captured by the image sensor of the imaging assembly may not comprise a bright region having an intensity greater than the intensity threshold. By comparing the intensity of the bright region to the intensity threshold and by monitoring which IR LED is ON, an identity of the pen tool may be determined.

Once the identity of the pen tool is determined, the identity may be used to assign an attribute such as for example a pen colour (red, green, black, blue, yellow, etc.) or a pen function (mouse, eraser, passive pointer) to the pen tool. In the event the pen tool is assigned the pen function of a mouse, the pen tool may be further assigned a sub-attribute such as for example a right mouse click, a left mouse click, a single mouse click, or a double mouse click. The pen tool may alternatively be associated with a particular user.

U.S. PAT. NO. 8,456,451 TO SMART TECHNOLOGIES ULC, THE CONTENTS OF WHICH ARE HEREIN explicitly incorporated by reference in its entirety, discloses active radio frequency (RF) pens used with an analog resistive touch sensitive screen having a controller capable of recording RFID tags broadcast by such pens when the pens are used to contact the touch surface. Since the controller of the touch sensitive screen receives pointer position data and the RFID tag when the RF pen is used to contact the touch surface but only receiving pointer position data when a finger is used to contact the touch surface, the computer is able to differentiate automatically between finger and RF pen contacts on the touch surface. The RFID tag may also be selected to specify the color of the RF pen. Active pens may also be used with a camera-based touch system.

U.S. Pat. No. 9,872,178 to SMART Technologies ULC, the contents of which are herein explicitly incorporated by reference in its entirety, discloses when a pointer is brought into contact with an NFC antenna, the pointer identifies itself as such to a pointer interface. The pointer interface requests a public key of the pointer and a biometric template corresponding to the user holding the pointer. The pointer interface compares the biometric template to the preexisting template stored in memory. If a successful match is found, the pointer interface transmits login information to the pointer.

The pointer has a processor executing instructions from volatile or non-volatile memory and storing data thereto. A battery supplies power to all the components of the pointer and may be rechargeable or non-rechargeable and replaceable. The pointer may have buttons allowing the user to change characteristics of the pointer such as virtual ink colour, style, or to initiate pairing between the pointer and a particular mobile device or communal device. The pressure on the pointer could also be used to modulate the thickness of the digital ink. The pointer has a transceiver coupled to an NFC antenna for pairing and communicating between the pointer and a particular mobile device or a particular communal device. Furthermore, the pointer has a transceiver coupled to a WiFi or Bluetooth antenna in order to communicate accelerometer/gyroscope, button, biometric sensor, or battery status information to the communal device. The pointer has a unique identifier stored within the memory thereof.

U.S. Pat. No. 11,188,173 to SMART Technologies ULC, the contents of which are herein explicitly incorporated by reference in its entirety, discloses a pen tool for use with an interactive input system having a plurality of antennas being placed behind the input touch area. The pen tool further comprises at least one coil and at least one NFC transponder. The at least one coil is configured to be activated by electromagnetic field generated by a set of selected antennas associated with a touch location of the tool approximate to the interactive input system, to power the at least one NFC transponder. The at least one NFC transponder is configured to transmit out an identifier associated with an attribute of the tool. The identifier is received by the interactive input system through the selected antenna for determining the attribute of the tool, such as color, erasing function or a particular user identity.

### SUMMARY

According to one aspect, an interactive input system is provided including an interactive input area for at least one tool to interact. The interactive input system comprises at least one touch sensor for detecting at least one touch of the at least one tool and a computing structure connected with the at least one touch sensor for determining at least one touch location of the at least one tool within the input area. In one aspect, the computing structure further comprises a tool detection module located adjacent to the interactive input area, and comprises at least one energy harvest transmitter, a transceiver, and a microcontroller. The at least one energy harvest transmitter is configured to transmit radio frequency (RF) signals via the at least one antenna to provide power to the at least one tool. The transceiver is configured to scan transmit packets from the at least one tool. The microcontroller is configured to identify an identity (ID) of each of the at least one tool from the transmit packets, and associate the ID with an attribute of each of the at least one tool interacting with the interactive input area.

According to another aspect, the computing structure is configured to identify at least one tool by: transmitting RF signals to power the at least one tool within range of the RF signals; scanning transmit packets from the at least one tool; and determining the ID from the transmit packets of the at least one tool. The computing structure is also configured to associate the ID with the attribute of the at least one tool.

According to a further aspect, a tool for use with an interactive input system is provided. The tool comprises an energy harvest antenna for receiving at least one RF signals; a circuitry for controlling a broadcasting of transmit packets and converting the RF signals to DC power; an energy storing device, such as capacitor, supercapacitor, and/or rechargeable battery, to store the DC power; and a low energy transmitter for transmitting transmit packets comprising an address and the ID data of the at least one tool. The circuitry may comprise a low power microcontroller, a low power radio module, and an RF to DC converter.

In another aspect, the tool may further comprise a tip pressure sensor and/or switch located near a writing end of a pointer and an end pressure sensor and/or switch located near an eraser end of the pointer. When the tool touches the input area of the interactive input system, the pressure sensor and/or switch is activated to send out an activation signal upon a pressure of the touch down event. The tool sends out transmit packets upon receiving the activation signal. When the tool is lifted off the input area, the pressure sensor and/or switch is off. The tool then stops sending out transmit packets when the pressure sensor and/or switch is off without any activation signal.

In another aspect, the tool may further comprise a vibration sensor for detecting a motion of the tool. When the tool is not in motion or no signal detected from the vibration sensor, the DC power is disconnected from the circuitry. The tool is in an off mode.

In another aspect, the tool may further comprise a magnetic sensor integrated inside the tool. When the tool is placed in a receptacle of the interactive input system, the DC power is disconnected from the circuitry to allow the tool to be in off mode.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a perspective view of an interactive input system;

FIG. 2 is a perspective view of tools for use with the interactive input system;

FIG. 3A is a perspective view of an exemplary pointer, showing internal components;

FIG. 3B is a cross sectional view of FIG. 3A;

FIG. 4 is a block diagram of a computing structure used in conjunction with the interactive input system of FIG. 1, for executing one or more methods for detecting the tools of the interactive input system;

FIG. 5 is a block diagram of details of a tool detection module of the computer structure of FIG. 4;

FIG. 6 is a flowchart of processing steps of a tool identification method;

FIG. 7 is a flowchart of processing steps of the tools communicating with the interactive input system;

FIG. 8A is a perspective view of another exemplary pointer;

FIG. 8B is a cross sectional view of FIG. 8A;

FIG. 9 is a block diagram of configuration of the pointer of FIGS. 8A and 8B; and

FIG. 10 is a flowchart of processing steps of the operation of the pointer of FIGS. 8A and 8B.

### DETAILED DESCRIPTION

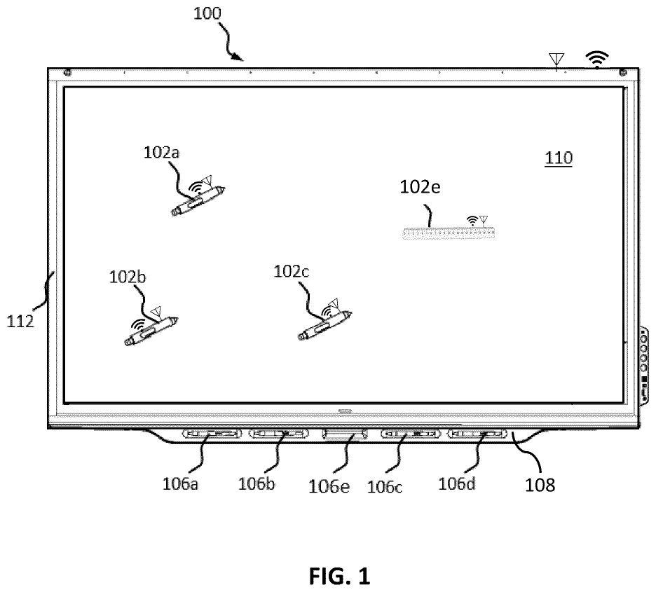

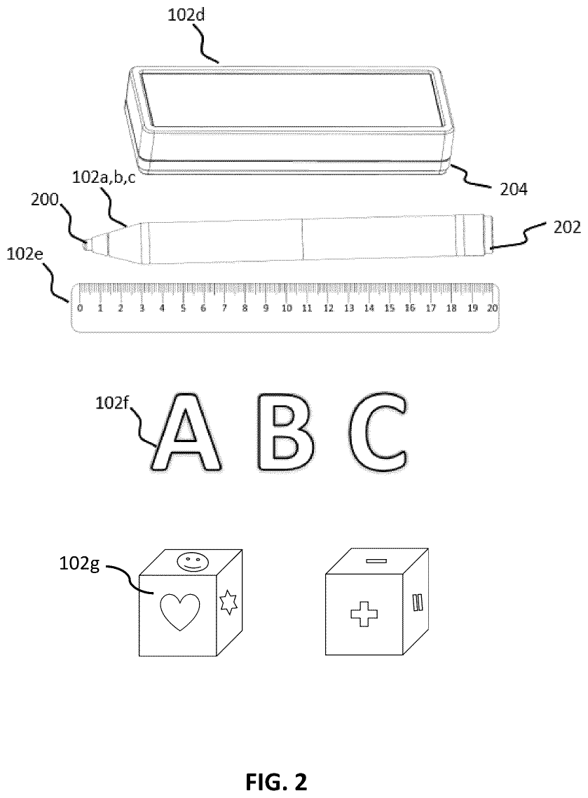

As shown in FIG. 1, an interactive input system 100 detects a position of one or more input tools 102 shown in FIG. 2 that may comprise pens or pointers 102a, 102b, 102c, one or more erasers 102d, one or more rulers 102e, one or more letters 102f, and/or one or more blocks or stamps 102g. The interactive input system 100 comprises an input area 110 that may be surrounded by a bezel 112 on a perimeter of the input area 110. The input area 110 may be aligned to a display projected thereon by a projector (not shown) or the input area 110 may overlay a display, such as an LCD display, LED display, OLED display, etc. A tool tray 108 is affixed to the interactive input system 100 adjacent to a bottom portion of bezel 112 using suitable fasteners such as for example, screws, clips, adhesive etc. One or more receptacles 106a-e are configured on the tool tray 108 and may receive the tools 102a-g, when the tools 102a-g are not in use. The receptacles 106a-e may be sized and/or shaped for their respective tool 102a-g. In some aspects, the receptacles 106a-e may have a magnet sensor integrated in each of the receptacles 106a-e.

One or more touch sensors (not shown) may observe the input area 110 to detect a presence of the input tool(s) 102a-g. When the touch sensors detect the presence of the input tool(s) 102a-g, the touch sensors may determine the position of each of the input tool(s) 102a-g. Each of the pointers 102a, b, c may correspond to a set of different pointer attributes. For example, pointer 102a may correspond to a red pointer that when placed in contact with the input area 110 generates virtual red ink in the input area 110; pointer 102b may correspond to a blue pointer that when placed in contact with the input area 110 generates virtual blue ink in the input area 110; and so forth. One or more attributes may be associated with the other tools 102d-g, such as an eraser size for tool 102d, a ruler length for tool 102e, a letter type for tool 102f, and/or a stamp for blocks 102g.

Although the touch system described herein is an optical touch system, the aspects described herein are not limited to certain types of touch systems. The touch system can be selected from any type of touch sensors, such as optical sensor, capacitive touch sensor, resistive touch sensor, electromagnetic induction sensor, and/or any combination.

An enlarged presentation of the input tools 102a-g is presented in FIG. 2. The pointer 102a, b, c may comprise a writing end 200 and an erasing end 202. When the writing end 200 is placed in contact with the input area 110, the interactive input system 100 registers digital ink at the position of the pointer 102a, b, c. Similarly, when the erasing end 202 is placed in contact with the input area 110, the interactive input system 100 removes the digital ink at the position of the pointer 102a, b, c. The eraser 102d may comprise a larger area 204 that when brought into contact with the input area 110 may delete a larger area of the digital ink at the position of the eraser 102d. When the ruler 102e is brought into contact with the input area 110, a ruler length is detected to show a length of an object in the input area 110. Or when the block 102g is in contact with the input area 110, a certain type of virtual stamp may be generated in the input area 110 to show approval or reward of activities performed in the interactive input system 100. According to some aspects, the input tools 102a-g may each comprise a magnet that may be detected by the magnet sensors associated with the receptacles 106a-e.

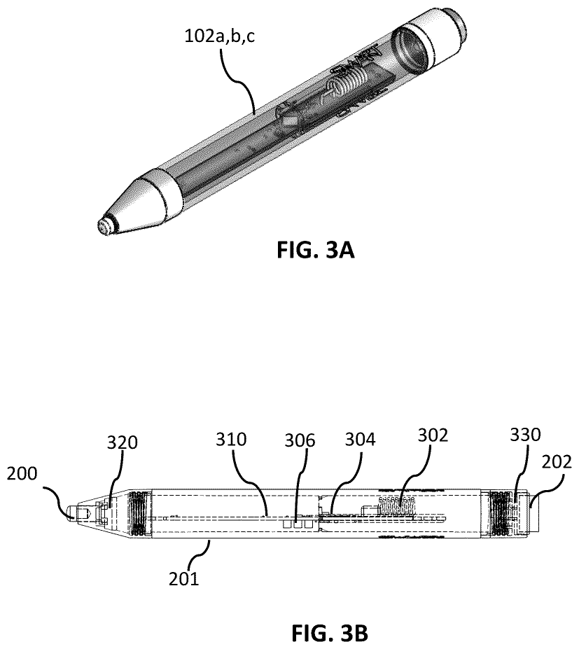

Turning to FIGS. 3A and 3B, an example of input tools, a pointer 102a, b, c is shown. Similar to the pointer 102a, b, c, each of the input tools 102a-g may comprise a RF energy harvest antenna 302. For example, the energy harvest antenna 302 may operate in an industrial, scientific and medical (ISM) band such as for example, 13.56 MHz, 900 MHz or 2.400 GHz. In this aspect, the antenna 302 may be located within a housing 201 of the pointer 102a, b, c, near the eraser end 202.

The input tools 102a-g may further comprise a circuitry 304 and an energy storing device, such as a capacitor/battery 306 in this example. The circuitry 304 may comprise a low power microcontroller, a low power radio module, and an RF to DC converter. When the input tools 102a-g are in use or close to the interactive input system 100, the input tools 102a-g may receive continuous waves of RF signals in ISM bands such as 13.56 MHz, 900 MHz or 2.400 GHz, which is transmitted from the interactive input system 100, through the energy harvest antenna 302. The continuous RF energy may be converted to DC power by the circuitry 304 and stored in the capacitor 306. With the above configuration and components of the energy harvesting components in the input tools 102a-g, the input tools 102a-g may not require any other power. Although a capacitor is used as the energy storing device 306 in this example, it should be understood by those persons skilled in the art on review of the present disclosure that other types of energy storing devices, such as supercapacitor or rechargeable battery, can be utilized.

In another aspect, each of the input tools 102a-g may further comprise a transmitter 310 such as a Bluetooth® low energy transmitter used to communicate with a transceiver, such as a Bluetooth transceiver in the interactive input system 100 based on the transmission protocol. The Bluetooth low energy transmitter 310 broadcasts Bluetooth signals, normally called transmit packets or advertisement packages. A transmit packet normally may contain an address and particular data information, such as identity (ID) data of the input tools 102a-g in the current application. The interactive input system 100 may determine an identity of the input tools 102a-g by analyzing the transmit packet, and further assign an attribute, such as colour, eraser, or ruler to each of the identified input tools. For example, each of input tools 102a-g may be configured to have a unique address and a unique ID data, which can be broadcasted as the transmit packet by the Bluetooth low energy transmitter 310. The ID data could be up to 29 bytes. A list of the unique addresses and ID data corresponding to all the input tools may be already added or stored in an approved whitelist in the interactive input system 100, which will be discussed in detail later. Alternatively, all the input tools 102a-g may be configured to have a same address in order for the interactive input system 100 to quickly scan and identify.

In another aspect, each of the input tools 102a-g may further comprise at least one pressure sensor/switch. When the input tools 102a-g are brought into contact with the input area 110, the pressure sensor/switch may be activated to generate an activation signal upon a pressure of the touch down event, which in turns wakes up the Bluetooth Low-Energy transmitter 310. The Bluetooth low energy transmitter 310 upon receiving the activation signal then broadcasts the transmit packets that contains tool's ID data informing the interactive input system 100 of the tool's ID. The interactive input system 100 detects the touch down event and reports the position of the touch. Meanwhile the tool's ID can also be determined. In the example of the pointer 102a, b, c shown in FIGS. 3A and 3B, a tip pressure sensor/switch 320 may be located within the house 201 near the pen end 200. A rear pressure sensor/switch 330 may be located near the eraser end 202.

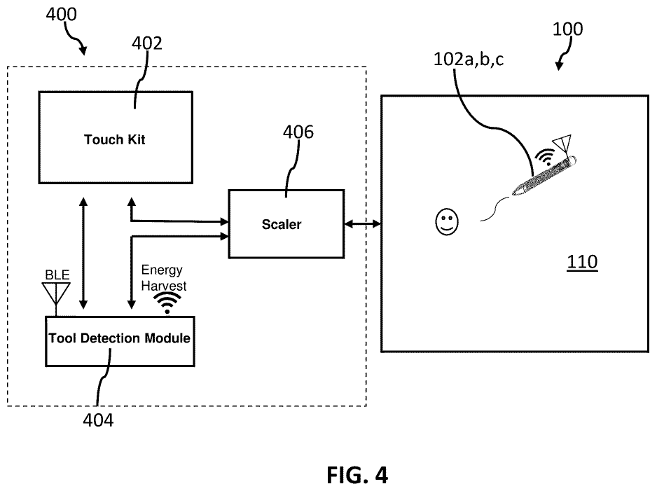

Referring to FIG. 4, a block diagram of a computing structure 400 used in the interactive input system 100 for touch position and tool's ID detection is shown. The interactive input system 100 includes touch sensors (not shown) as discussed above to detect the presence of the input tools 102a-g, such as a pointer 102a, b, c discussed in FIGS. 3A and 3B, for generating virtual ink in the input area 110. The interactive input system 100 includes the computing structure 400 for determining touch positions and an identity (ID) of each of the pointer 102a, b, c. Specifically, the computing structure 400 may comprise a touch kit 402 for immediately detecting touch positions of multiple input tools and a tool detection module 404 for detecting each input tool's ID.

The touch kit 402 may detect a pen down event and report a set of X/Y coordinates of the touch to the tool detection module 404. The touch kit 402 can be any type of touch detection processor that may be able to calculate the positions of the input tools in the input area 110, such as that disclosed but not limited in US. U.S. Pat. No. 8,692,768 and US. U.S. Pat. No. 9,292,109, the contents of which are each explicitly herein incorporated by reference in its entirety. The touch kit may be a processing structure based on IR distributed emitters/transmitters, capacitive touch, resistive touch, etc.

The tool detection module 404 may receive the tool ID information from the input tools 102a-g upon a touch down event of each of the input tools 102a-g, and process the information to determine a corresponding ID for each of the input tools 102a-g. The tool detection module 404 may further receive touch position data from the touch kit 402 and associate the touch position data with a corresponding input tool. The results processed by the tool detection module 404 may be transferred to the scaler 406. The scaler 406 may process the data from different subsystems including the touch kit 402 and the results from the tool detection module 404, and may combine them for rendering on the input area 110 as virtual ink or strokes (touch position) with an associated attribute such as color, eraser or any other type of event (ruler/letter/cube/stamp, etc.). The interactive input system 100 may allow support for “infinite” (e.g. an arbitrarily large number exceeding a number of users of the interactive input system 100) types of different input tools 102a-g. Numerous input tools can be used simultaneously on the input area 110.

In one aspect, the computing structure 400 that includes the touch kit 402, the tool detection module 404, and the scaler 406 may be mounted on a board (not shown), for example, within a housing under the tool tray 108. Those persons skilled in the art would understand that the components of the computing structure 400 may be installed in some other locations of the interactive input system 100, such as behind a side portion of the bezel 112.

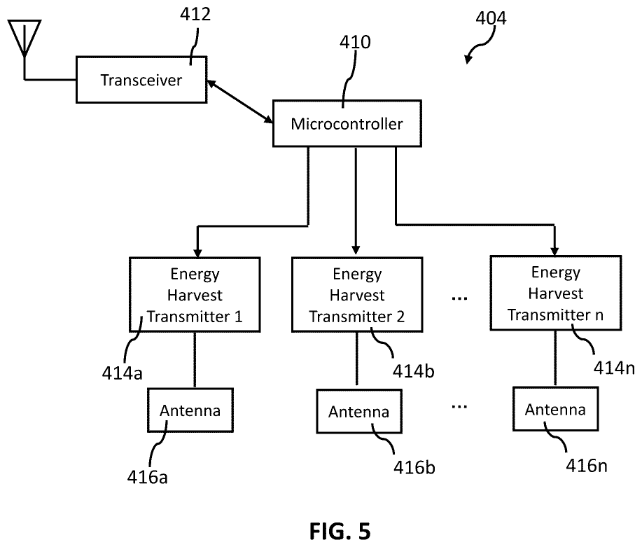

FIG. 5 is a block diagram of the tool detection module 404 of the computer structure 400, showing detailed components. The tool detection module 404 may comprise a microcontroller 410, a transceiver 412, such as a Bluetooth transceiver, at least one energy harvest transmitter 414, and an antenna 416 connected with each of the energy harvest transmitter 414. The example of FIG. 5 shows transmitter-1 414a, transmitter-2 414b, and their corresponding antennae 416a and 416b respectively. Of course, those persons skilled in the art would understand that the number (n) of transmitters 414 may depend on a size of the interactive input system 100. Smaller interactive input system 100 may require only one transmitter 414, while a larger interactive input system 100 such as an 86-inch display may require multiple transmitters 414. Using multiple transmitters 414 may ensure enough power all around the screen so that the user can keep charging the tool 102a-g while using it. Due to power limits imposed by a regulator that each transmitter 414 can generate, distributing power throughout the interactive input system 100 in this application effectively guarantees proper operations of charging at all times.

The energy harvest transmitters 414a-n also operates in the ISM band such as 900 MHz or 2.4GHz, and transmits continuous waves of RF signals through antennas 416a-n. The RF signals are captured by the energy harvest antenna 302 in the input tools 102a-g when the input tools 102a-g are in use or stored in the receptacle 106a-e of the pen tray 108, and then rectified and converted to DC power. The DC power may be stored in the energy storing device, such as capacitor 306 in this example, inside the input tools 102a-g. The tool detection module 404 may allow for charging unlimited (e.g. an arbitrarily large number exceeding the number of users of the interactive touch system 100) number of input tools 102a-g in the energy harvest field of view.

The transceiver 412 may continuously scan the transmit packets from the input tools 102a-g. The transmit packets from multiple input tools received by the transceiver 412 may be sent to the microcontroller 410 for processing to identify the tool's ID. Multiple input tools can be detected and determined by the microcontroller 410. The tool detection module 404 may allow multiple users to simultaneously write on the interactive input system 100 with pointers or other type of input tools (stamps/cube/letters/etc.) 102a-g and/or finger touches.

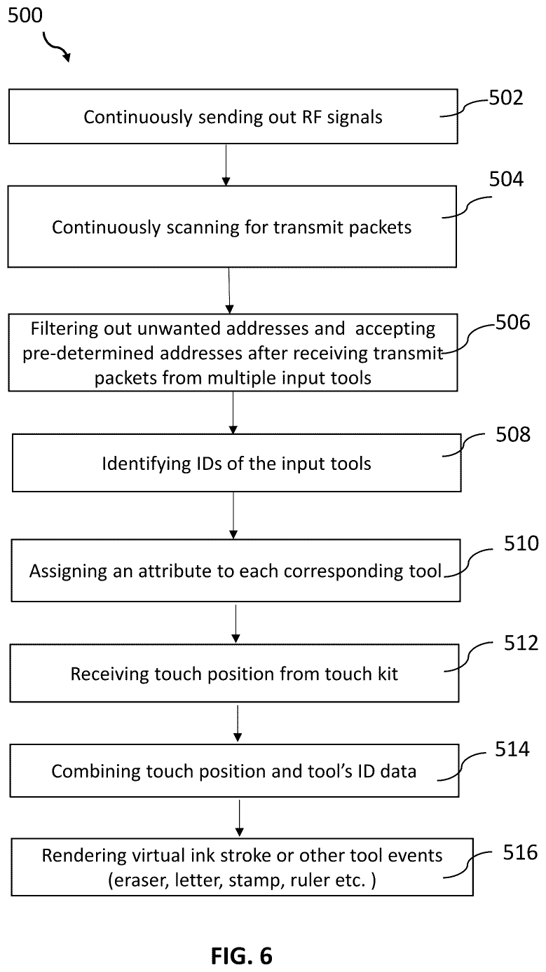

Turning to FIG. 6, an operation process 500 of a tool identification method is described in detail. The energy harvest transmitter 414a-n may continuously send out RF signals through antenna 416a-n at step 502. It keeps charging the input tools 102a-g when the input tools 102a-g may be close to the interactive input system 100. At the same time, the transceiver 412 may continuously scan for transmit packets that contain addresses and tool's ID data at step 504.

In one aspect, each of the input tools 102a-g may be configured to broadcast the transmit packets only when the input tools 102a-g touch the input area 110 and activate the pressure sensor or switch 320. In particular, the input tools 102a-g may broadcast initial two to four transmit packets in a quick succession upon the touch down event. The initial transmit packets may not be periodic but asynchronous in quick succession. This process ensures the transmit packets may be safely received by the transceiver 412. After that, the tool 102a-g may transmit periodically at an interval, such as around 200-ms. These transmit packets may need to be sent out with minimal latency so that the interactive input system 100 reacts quickly (e.g. within a response latency suitable for natural movement to the user. The transmit packet may be repeated to ensure reception by the interactive input system 100.

When the input tools 102a-g are lifted off and not in contact with the input area 110, the transmit packets stop to conserve energy. The choice of using one primary channel for communicating the transmit packets can reduce potential noise or interference from other radio frequency devices in the environment.

After receiving one or more transmit packets, the microcontroller 410 may filter the pre-determined addresses of all input tools on the input area 110 at step 506. In one aspect, the microcontroller 410 may filter out those unwanted addresses not in the whitelist, namely non-acceptable input tools, and to accept pre-determined addresses from acceptable input tools 102a-g. In one aspect, the multiple input tools 102a-g may be configured to have a same address. This allows the tool detection module 404 to quickly filter out those unwanted addresses. Those unwanted transmit packets without the pre-determined address can be filtered out to improve latency and performance of the tool detection module 404. There may be no need to pair each input tool 102a-g with each interactive input system 100 so that the input tools 102a-g can be used with any of the interactive input system 100 having current technology without requiring pairing (e.g. without the touch panel 100 having to know specific details about the input tools 102a-g).

In another aspect, each of the multiple input tools 102a-g may be programmed with a pre-determined address. Multiple pre-determined addresses may be added to an approved whitelist in the tool detection module 404. When the transceiver 412 is scanning for devices, other nearby devices without the pre-determined addresses can be filtered out. The input tools 102a-g with the pre-determined addresses can be filtered and recognized. The tool detection module 404 may be able to detect multiple addresses. Therefore, multiple input tools 102a-g can be identified.

Once the acceptable addresses of the input tools 102a-g are recognized, each tool's ID data may be received by the microcontroller 410 through the transceiver 412 and the IDs of the input tools can be identified at step 508. An attribute, such as colour, eraser, letter, or ruler, may be assigned to each of the corresponding input tools 102a-g at step 510. At the same time, the touch kit 402 may detect the input tool touch down event on the input area 110, and reports the touch position, such as the X/Y coordinates to the microcontroller 410. Namely, the touch position of each of the identified input tools 102a-g from the touch kit 402 is received by the microcontroller 410 at step 512. The microcontroller 410 then combines the touch position and the ID data at step 514. The virtual ink stroke or other tool events such as eraser, letter, stamp or ruler, etc. are rendered on the input area 110 at step 516.

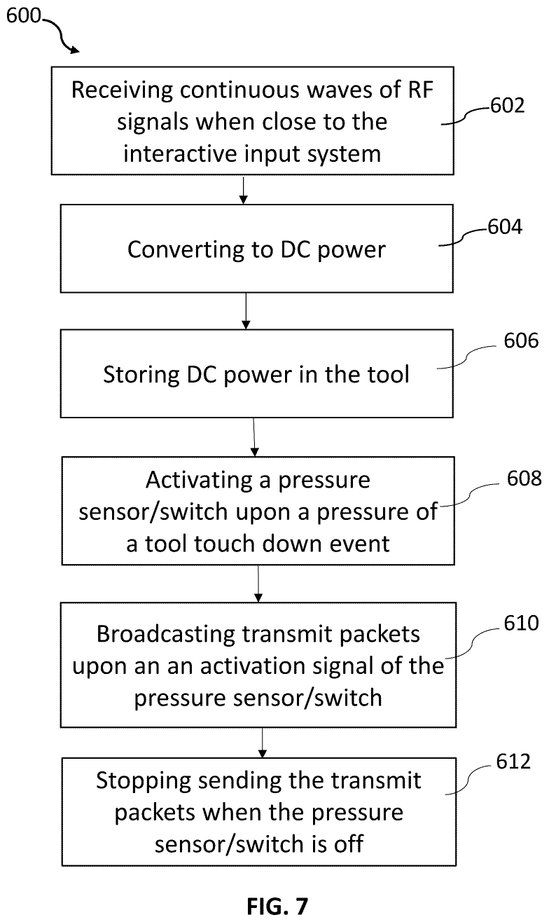

Referring to FIG. 7, an operation process 600 of the input tools 102a-g is discussed. When the input tools 102a-g are in use or close to the interactive input system 100, or stored in the receptacles 106, the input tools 102a-g may receive continuous wave of RF signals through energy harvest antenna 302 at step 602. The RF signals are then converted to DC power at step 604 by circuitry 304. The DC power may then be stored in the energy storing device 306 of the input tools 102a-g at step 606.

In one aspect, as the input tools 102a-g may be in contact with the input area 110 at the touch down event, a pressure may be applied on the writing end 200 or the eraser end 202, which in turn activates the pressure sensor/tip switch 320 or the back pressure sensor/switch 330 at step 608. An activation signal may be generated to trigger the low energy transmitter 310 to broadcast the transmit packets at step 610. The transmit packets may be scanned by the transceiver 412 and sent to microcontroller 410 for process to determine IDs of the input tools 102a-g as discussed with reference to FIG. 6.

When the input tools 102a-g are lifted off and not in contact with the input area 110, the pressure sensor/switch may be automatically turned off. The input tools 102a-g may immediately stop broadcasting the transmit packets at steps 612. This process may conserve the energy of the input tools 102a-g. The radio frequency communication between the input tools 102a-g and the interactive input system 100 may consume very low power. The input tools 102a-g can be powered from the stored power through energy harvest components without the need of additional costly components, such as ferrites/custom coils typically utilized in the interactive input systems. When the input tools 102a-g are close to the interactive input system 100, the input tools 102a-g may continue to be charged by the energy harvest components as discussed from step 602 to step 606.

Alternatively, the input tools 102a-g may be optimized to include a long-lasting battery and a plurality of sensors for saving the power of the pen tool during the operation.

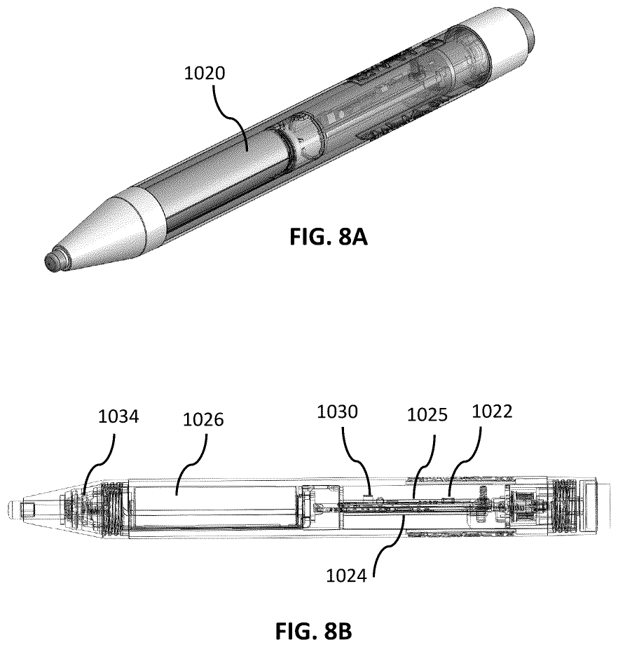

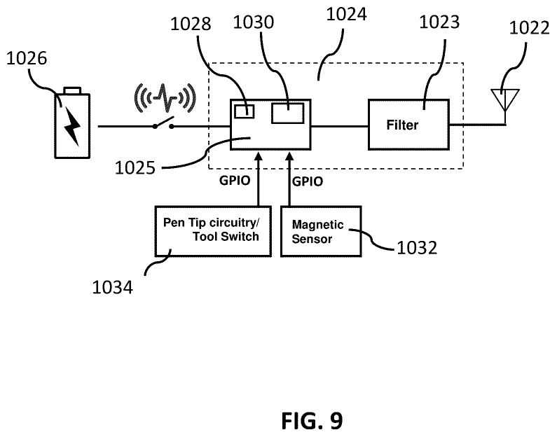

Referring to FIGS. 8A to 9, another exemplary tool, such as a pointer 1020 is shown. The pointer 1020 may comprise an antenna 1022, a battery 1026, and a control circuitry 1024 including a radio module 1025 for sending transmit packets. In one aspect, the control circuitry 1024 may comprise a filter 1023 used to suppress (attenuate) harmonics generated from the radio module 1025.

In one aspect, the control circuitry 1024 may include a vibration sensor 1028 and an ultralow power vibration sensor circuitry 1030 that are integrated inside the pointer 1020 to disconnect the battery when the pointer 1020 is not in use. In other words, when the vibration sensor 1028 detects a motion of the pointer 1020, the vibration sensor circuitry 1030 generates a signal to notify the control circuitry 1024 that the pointer 1020 is in use. Conversely, when no signal is generated by the vibration sensor 1028, the pointer 1020 is not in use. The control circuitry 1024 disconnects the battery 1026 with the components in the pointer 1020. As a result, when the pen tool or the pointer 1020 is not in motion (e.g. placed in any position such as a flat or vertical orientation, or in any other direction without movement), the battery 1026 or the stored charge from energy harvesting / wireless charging or the capacity discussed previously is preserved. The vibration sensor circuitry 1030 may be optimized to consume a current in a nanoamp range. The only power discharge is related to the self-discharge of the energy storage components such as the battery 1026, along with nano-amps current from the vibration sensor circuitry 1030.

In another aspect, the pointer 1020 may further comprise a magnetic sensor 1032 integrated inside the pointer 1020. When the pointer 1020 is placed in one of the receptacles 106a-e of the interactive input system 100, which may have a magnet, the pointer 1020 may send out a radio signal to inform the interactive input system 100 that the pointer 1020 is placed in one of the receptacles 106a-e.

The pointer 1020 may also comprise a pressure sensor/switch 1034 located within the tip end of the pointer 1020. The transmit packets containing pointer's ID data may be broadcasted upon activation of the pressure sensor/switch 1034.

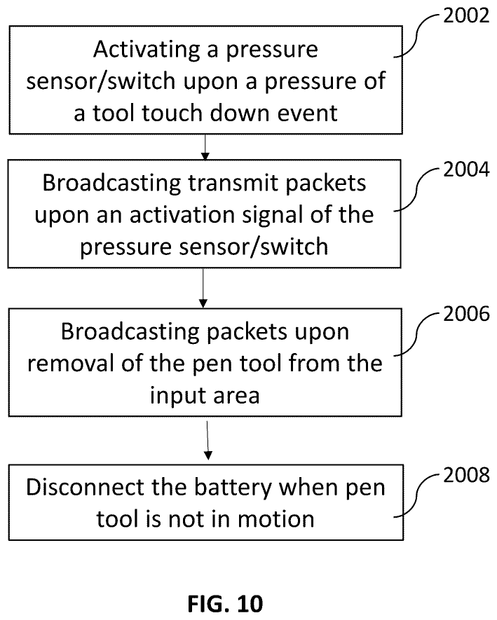

The operation of the pointer 1020 is illustrated with reference to the flowchart shown in FIG. 10. Upon a pressure of a touch down event of the pointer 1020, the pressure sensor/switch 1034 is activated to generate an activation signal at step 2002. Upon receiving the activation signal, the control circuitry 1024 sends a command to the radio module 1025 so that transmit packets are broadcasted via antenna 1022 at step 2004. Communications between the pointer 1020 and the interactive input system 100 may be mostly one way in this aspect. The pointer 1020 may then communicate with the interactive input system 100 through various transmit packets. Through the various transmit packets, the pointer 1020 notifies the interactive input system 100 of the events such as tip press, eraser press, and pen placed in the pen tray through the magnetic sensor as discussed herein. For example, when the pointer 1020 is lifted off from the input area 110, the pressure sensor/switch 1034 is released. A transmit packet containing data information that the pointer 1020 is removed from the input area 110 is broadcasted to notify the interactive input system 100 at step 2006.

According to another aspect, When the switch/pressure 1034 is activated and a general purpose input/output (GPIO) pin on a microcontroller unit (MCU) in the control circuit 1024 may change states from low to high or high to low. This change in state initiated a hardware interrupt to wake the MCU and the integrated radio module 1025 on the pointer 1020. The radio module 1025 becomes active and transmits packets containing information of the nature of the GPIO event that had just occurred (for example pen tip switch closed/opened, eraser end switch closed/opened), to inform the interactive input system 100 of a tool event. After the transmit packets are broadcasted, the radio module 1025 and MCU on the pointer 1020 immediately turn back into off or sleep mode.

In another aspect, multiple transmit packets are sent in quick succession depending on the priority of the event. For tip/eraser/tool press, which is the highest priority, the pointer 1020 sends four transmit packets. For tip or eraser release, the pointer 1020 sends one transmit packet. The number of packets per event is selected to increase battery life (e.g. less power required to send out lower priority packets as fewer number of packets are sent).

In another aspect, the battery 1026 is disconnected with the control circuitry 1024 when the pointer 1020 is not in motion at step 2008.

According to another aspect, the transmit packets are broadcasted as fast as the control circuitry 1024 can send, which optimizes the time when the radio module 1025 is awake.

The aspects described herein may apply equally well to any educational or enterprise tools 102, such as letters, numbers, shapes, rulers, highlighters, and/or compass etc., and may allow for multiple tools/objects to be identified to the interactive input system 100. Those persons skilled in art would understand that the input tools 102a-g are not limited to pens/rulers/letters as discussed above. The input tools 102a-g can be stamps, highlighters, mathematical educational tools such as compass, etc. Any object may be used as the tools 102a-g in education or enterprise applications.

Although primary channels have been discussed to transmit the advertisement packages, those persons skilled in art would understand that any of the other channels may be used even though some may not be advertising channels.

The foregoing is considered as illustrative only of the principles of the invention. Further, since numerous changes and modifications may readily occur to those skilled in the art, it is not desired to limit the invention to the exact construction and operation shown and described, and accordingly, all such suitable changes or modifications in structure or operation which may be resorted to are intended to fall within the scope of the claimed invention.

1. An interactive input system including an input area for at least one tool, comprising:
at least one touch sensor for detecting the at least one tool;
a computing structure connected with the at least one touch sensor for determining at least one touch location of the at least one tool within the input area;
wherein the computing structure comprises a tool detection module comprising at least one energy harvest transmitter, at least one antenna, a transceiver, and a microcontroller;
wherein the at least one energy harvest transmitter is configured to transmit radio frequency (RF) signals via the at least one antenna to provide power to the at least one tool;
the transceiver is configured to scan transmit packets from the at least one tool; and
the microcontroller is configured to identify an identity of each of the at least one tool and to associate the ID with an attribute of the at least one tool interacting with the input area.

2. The interactive input system of claim 1, wherein the at least one energy harvest transmitter operates in an industrial, scientific and medical band and continuously transmits the RF signals.

3. The interactive input system of claim 1, wherein the tool detection module comprises a plurality of energy harvest transmitters and a plurality of antennas.

4. The interactive input system of claim 1, wherein the transceiver is a low-power radio and is configured to use at least one channel to scan the transmit packets.

5. The interactive input system of claim 1, wherein the attribute of the at least one tool comprises at least one of: color, eraser, letter, stamp, and ruler.

6. The interactive input system of claim 1, wherein the computing structure is further configured to identify the at least one tool and is configured to:
transmit the RF signals to provide the power to the at least one tool within range of the RF signals;
scan the transmit packets from the at least one tool;
determine the identity from the transmit packets of the at least one tool; and
associate the identity with the attribute of the at least one tool.

7. The interactive input system of claim 6, wherein each of the transmit packets contains at least one pre-determined address and identity data.

8. The interactive input system of claim 7, wherein the computing structure is further configured to: filter the at least one pre-determined address from the transmit packets before determining the identity.

9. The interactive input system of claim 6, wherein the transmit packets are broadcasted from the at least one tool in response to a touch-down on the input area with the at least one tool.

10. The interactive input system of claim 6, wherein the transmit packets are stopped when the at least one tool is lifted off the input area.

11. A tool for use with an interactive input system, comprising:
an energy harvest antenna for receiving at least one RF signal;
a circuitry for controlling a broadcasting of transmit packets and converting the at least one RF signal to a DC power;
an energy storing device to store the DC power; and
a transmitter for broadcasting the transmit packets comprising an address and ID data of the tool.

12. A tool for use with an interactive input system, comprising:
a battery for providing a DC power to the tool;
a transmitter for broadcasting a plurality of transmit packets containing an address and identity data of the tool;
a vibration sensor for detecting a motion of the tool; and
a circuitry for controlling broadcasting the transmit packets.

13. The tool of claim 11 further comprising: a pressure switch, wherein the pressure switch activates upon a pressure of a touch down event, and the pressure switch is off when the tool is lifted off an input area.

14. The tool of claim 13, wherein the transmitter broadcasts the transmit packets upon activation of the pressure switch.

15. The tool of claim 13, wherein the transmitter stops broadcasting the transmit packets when the pressure switch is off.

16. The tool of claim 12, wherein the DC power is only connected to the circuitry when the vibration sensor detects the motion of the tool.

17. The tool of claim 11, further comprises a magnetic sensor integrated inside the tool, wherein the DC power is disconnected when the tool is placed in a receptacle of the interactive input system.

18. The tool of claim 11, wherein the at least one RF signal is at frequencies around 13.56 MHZ, 900 MHz, or 2.400 GHz.

19. The tool of claim 12 further comprising: a pressure switch, wherein the pressure switch activates upon a pressure of a touch down event, and the pressure switch is off when the tool is lifted off an input area.

20. The tool of claim 12, further comprise a magnetic sensor integrated inside the tool, wherein the DC power is disconnected when the tool is placed in a receptacle of the interactive input system.
